(19) United States
(12) Patent Application Publication
(10) Pub. No.: US 2015/0251526 A1
(43) Pub. Date: Sep. 10, 2015

(54) ROLLER BLIND SYSTEM FOR A SLIDING ROOF

(71) Applicants: Joachim ROEDER, Muhlheim (DE); Peter RIEGER, Aschaffenburg (DE); Rainer ARNOLD, Schotten (DE); Stefan KUNKEL, Aschaffenburg (DE); Klaus DUDEL, Biebergemund (DE); Daniel SCHWEINOCH, Maintal (DE)

(72) Inventors: Joachim ROEDER, Muhlheim (DE); Peter RIEGER, Aschaffenburg (DE); Rainer ARNOLD, Schotten (DE); Stefan KUNKEL, Aschaffenburg (DE); Klaus DUDEL, Biebergemund (DE); Daniel SCHWEINOCH, Maintal (DE)

(21) Appl. No.: 14/636,992

(22) Filed: Mar. 3, 2015

(30) Foreign Application Priority Data
Mar. 6, 2014 (DE) 102014002961.1

(51) Int. Cl. B60J 7/06

(52) U.S. Cl. CPC B60J 7/067

(57) ABSTRACT

A roller blind system for a sliding roof with at least one guide rail and with a roller blind with a roller blind fabric mounted on at least one guiding strip is provided, The guiding strip is sectionally guided in the guide rail and its end that is located outside the guide rail contracts to form a coil during a movement of the roller blind in opening direction, wherein at least one device for increasing the opening force of the roller blind is provided, which is designed and arranged such that the device produces an additional force at least in opening direction.

### CROSS REFERENCE TO RELATED APPLICATIONS

This application claims foreign priority to DE 10 2014 002 961.1 filed Mar. 6, 2014, under 35 U.S.C. §119, the entire contents of which are incorporated herein by reference thereto.

### TECHNICAL FIELD

This invention relates to a roller blind system for a sliding roof with at least one guide rail and with a roller blind with a roller blind fabric mounted on at least one guiding strip, wherein the guiding strip is sectionally guided in the guide rail and its end located outside the guide rail contracts to form a coil during a movement of the roller blind in opening direction.

### BACKGROUND

Such roller blind system is known from EP 1 900 560 A1. The advantage of this roller blind system consists in that it is very compact. The guiding strip designed as spring steel strip serves both for fastening the roller blind and as return spring. It was found out, however, that the operating forces which are necessary for shifting the roller blind in the guide rail change in dependence on the shifting direction. When the roller blind is moved towards a more closed position, i.e. is pulled out, higher operating forces are necessary than for pushing back and winding up the roller blind system into a more open state. In addition, it was found out that the operating forces rise with increasing pull-out of the roller blind, when the roller blind system is moved towards a more closed position. In general, different and/or changing operating forces are regarded as an annoyance by the user. The roller blind system known from EP 1 900 560 A1 by means of a compensation spring achieves that the operating force in opening direction and in closing direction is constant due to the compensation spring. In this known roller blind system it is found to be disadvantageous that an increased space requirement and also higher manufacturing costs are obtained because of the compensation spring.

It is the object of the invention to develop a roller blind system as mentioned above to the effect that operating forces are obtained, which provide for a more comfortable operation without having to take up more installation space.

### SUMMARY OF THE INVENTION

According to the invention, this object is solved by a roller blind system as claimed herein.

In one embodiment, a roller blind system for a sliding roof is provided. The roller blind system having at least one guide rail and with a roller blind with a roller blind fabric mounted on at least one guiding strip, wherein the guiding strip sectionally is guided in the guide rail and its end located outside the guide rail contracts to form a coil during a movement of the roller blind in opening direction, characterized in that at least one device for increasing the opening force of the roller blind is provided, which is designed and arranged such that the device produces an additional force at least in opening direction.

Accordingly, it is provided that a roller blind system for a sliding roof includes at least one guide rail and a roller blind with a roller blind fabric mounted on at least one guiding strip, wherein the guiding strip sectionally is guided in the guide rail and its end located outside the guide rail contracts to form a coil during a movement of the roller blind in opening direction, wherein at least one device for increasing the opening force of the roller blind is provided, which is designed and arranged such that the device produces an additional force at least in opening direction.

An embodiment of the invention is based on the fundamental idea that in addition to the coil which exerts a restoring force on the movable components of the roller blind system, such as roller blind fabric and guiding strip, a further device is provided, which modifies the actual construction-related roll-up behavior and the forces which occur for opening and closing the movable components of the roller blind system. Due to construction, the actuating force is smaller in opening direction than in closing direction, since the guiding strip is wound up automatically in opening direction. The actuating force thereby is reduced in opening direction. This is undesired for example according to customer specifications. In particular, it is regarded as pleasant when the opening force to be applied does not decrease so much with increasing opening. By artificially increasing the actuating force in opening direction, the invention ensures that the required force for opening the roller blind matches or at least partly matches the actuating force in closing direction.

The device need not necessarily produce an additional force in closing direction, it possibly also can be ineffective in closing direction.

There are obtained operating forces which provide for a more comfortable operation, wherein the roller blind in general, however, does not take up more installation space.

The device preferably is a separate device which exclusively serves for increasing the resistance.

Furthermore, the device can consist of several individual devices, which each already influence the opening or closing force.

The guiding strip for example can be a spring steel strip.

The additional force produced by the device can be greater than an additional force possibly produced by the device in closing direction.

According to one embodiment of the invention it can be provided that the device for increasing the opening force also increases the closing force for moving the roller blind in closing direction. This provides for a selective adjustment of the opening force and the closing force corresponding to the specifications of car manufacturers. The operating characteristics hence can be adjusted as desired.

A target can be that the required opening force for moving the roller blind or the movable components of the roller blind in opening direction and the required closing force for moving the roller blind or the movable components of the roller blind system in closing direction lie in a tolerance field of e.g. about 10-20 N±10 N (i.e. nominal force about 10-20 N, tolerance±10 N) or about 10-20 N±5 N (i.e. nominal force about 10-20 N, tolerance±5 N).

Without the additional force which is produced by the device for increasing the opening force, the required opening force for moving the roller blind in opening direction for example can lie in a range of about 5 N to 10 N and the closing force for moving the roller blind in closing direction can lie in a range of about 10 N to 30 N. The additional forces in opening direction and closing direction produced on the part of the device for increasing the opening force advantageously are dimensioned such that the total opening force required and the total closing force required lie close to each other and within the specified tolerance field.

The device for increasing the opening force can increase the resistance for the movement of the roller blind. Experience has shown that too smoothly running roller blind systems cannot be opened into a desired position with sufficient accuracy. It is not desired either when a movement of the roller blind also can be triggered by the driving movement of the vehicle. Therefore, it is regarded as desired and advantageous when a certain minimum resistance must be applied for a movement of the roller blind, namely both in opening direction and in closing direction.

In a further embodiment, the device furthermore can include at least one friction element which is arranged such that it artificially increases the opening force. In principle, the use of the friction principle for adjusting the opening force and closing force also is possible advantageously with tight tolerance specifications.

Furthermore, it can be provided that the friction element is designed and arranged such that it produces a higher frictional force in opening direction than in closing direction. In principle, several friction elements might be provided, one of which acts in the one direction and the other in the other direction. The discussed variant, however, operates with a friction element which influences the frictional force in both directions of movement.

Advantageously, the frictional force is influenced differently in opening direction and in closing direction.

The friction element can be transferable into at least two different positions, in which the resistance caused by the friction element is different. The frictional force in opening direction and the frictional force in closing direction thereby can be adjusted easily and precisely. In particular, it is conceivable that in dependence on the position a different frictional force each is obtained, in particular is obtained on its own, i.e. automatically, namely during and caused by the change in the direction of movement of the roller blind.

In a further aspect of the invention, during a movement in opening direction the friction element can be in a first position in which the friction element is pressed and braced against a wall, and during a movement in closing direction can be transferred into a second position in which the friction element is not pressed against a wall and not braced, in particular wherein by changing the direction of movement of the roller blind the friction element is transferred into the respectively other position.

By pressing and bracing the friction element against a wall or a stop a higher frictional force can easily be produced in the first position, which then artificially increases the necessary opening force and is higher than the closing force. In the second position, the friction element can be untensioned and be in contact with the wall or away from the wall or the stop. Due to the missing contact pressure in this position, a lower frictional force is obtained automatically.

In one embodiment of the invention, the friction element can be a friction wedge. This in particular provides for a simple and inexpensive design and provision of the friction element. A manufacture within close tolerances also is easily possible. The use of a friction wedge involves the advantage that for example with a corresponding arrangement a friction wedge can be transferred from the first into the second position and vice versa only due to the movement of the roller blind, in particular by linear displacement along a specified path.

The friction wedge can be arranged in a wedge guide. The movement of the roller blind fabric can urge the friction wedge against a wall in opening direction such that an additional frictional force is produced.

Furthermore, it can be provided that the friction element is a pivotally mounted friction piece. This is a simple construction easy to realize, which operates reliably. Here as well, the movement in opening direction can urge the friction piece against a wall such that an additional frictional force is produced in that the friction piece is braced or tightened so to speak between wall and guide rail. A movement in closing direction leads to a rotation or pivotal movement of the friction piece, so that the friction piece without stop only slides across the wall and no high frictional force can be produced any more. The friction element also can be an expanding spring. During a movement in opening direction, the expanding spring can be shifted into a first position in which the expanding spring presses against a wall, e.g. a wall of the guide rail, and is tightened between the wall and the guide and thereby produces a high frictional force. During a movement in closing direction, the expanding spring can be transferred into a second position in which the expanding spring is at least partly contracted and therefore does not press against the wall or only with a small force.

The friction element can at least partly be elastic or at least have an elastomeric portion or an elastomeric friction surface. This provides for manufacturing at reasonable cost expenditure within a narrow tolerance range.

Advantageously, the bearing also is designed elastic or resilient.

Furthermore, it can be provided that the friction element is at least partly made of a silicone material. A partly elastic friction element thereby can be provided easily and at low cost.

During a movement of the roller blind in opening direction, the friction element can be urged against the guide rail, in order to produce an additional frictional force.

It can also be provided that the roller blind system includes at least one slider which is guided in the guide rail, wherein the friction element is guided on or in the slider. The slider can be part of the crossrail or end element of the crossrail which is guided in the guide rail.

### BRIEF DESCRIPTION OF THE DRAWINGS

The invention will be described below with reference to various embodiments which are represented in the attached drawings, in which:

FIG. 1 shows a perspective view of a vehicle roof with a roller blind system according to the invention;

FIG. 2 shows a schematic side view of a roller blind used in the invention;

FIG. 3 shows a section along the plane III-III of FIG. 1;

FIG. 4 shows the section IV of FIG. 2 on an enlarged scale;

FIG. 5 shows a sectional drawing through a slider of a first embodiment of a roller blind system according to the invention in a first position;

FIG. 6 shows a sectional drawing through a slider of the first embodiment of a roller blind system according to the invention in a second position;

FIG. 7 shows a sectional drawing through a slider of a second embodiment of a roller blind system according to the invention in a first position;

FIG. 8 shows a sectional drawing through a slider of the second embodiment of a roller blind system according to the invention in a second position;

FIG. 9 shows a sectional drawing through a slider of a third embodiment of a roller blind system according to the invention in a first position; and

FIG. 10 shows a sectional drawing through a slider of the third embodiment of a roller blind system according to the invention in a second position.

### DETAILED DESCRIPTION

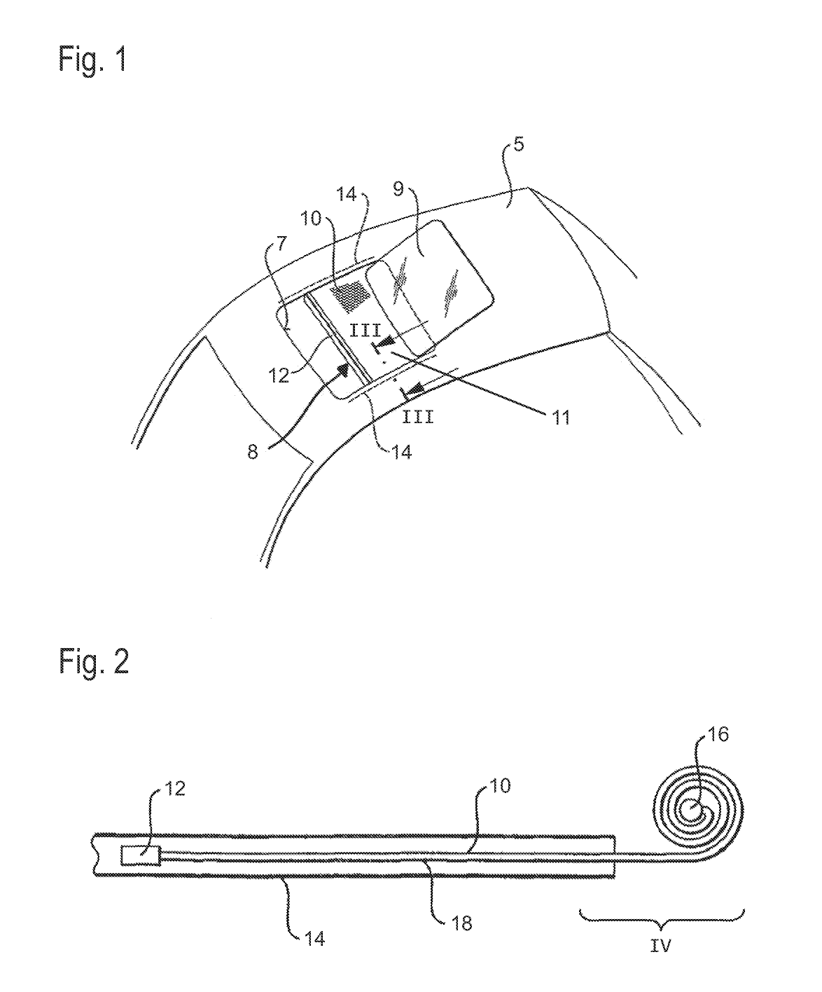

FIG. 1 shows a vehicle roof 5 which is provided with an opening 7 and a roller blind system 8. To the opening 7 a cover 9 of a sliding roof system is associated. The cover 9 can be shifted between a closed position, in which it closes the opening 7, and an open position which is shown in FIG. 1. Below the cover 9 and also below the opening 7 a roller blind 10 is arranged, which is part of the roller blind system 8. The roller blind 10, based on the vehicle, can be shifted back and forth. When the roller blind 10 is pushed back completely, the opening 7 is cleared completely. Fresh air and sunlight then have free access to the vehicle interior space. When the roller blind 10 is pushed forward completely, the opening 7 is covered by the roller blind 10. Fresh air and sunlight thus can get into the vehicle interior space only to a limited extend.

The roller blind 10 comprises a roller blind fabric 11 of a flexible material, for example cloth or a plastic film. At its front end a crossrail 12 is provided, which can be grasped by a vehicle occupant in order to shift the roller blind 10 back or forth. Laterally along the opening 7 two guide rails 14 extend, which likewise are part of the roller blind system 8 and in which the two longitudinal edges of the roller blind fabric, i.e. the right and left edge of the roller blind fabric 11 as seen in longitudinal vehicle direction, are accommodated. In the region of the rear end of the opening 7 the rear edge of the roller blind 10 is located, at which a coil body 16 is mounted. The coil body is not mounted on the roof; it can be designed as plastic strip which is injection-molded onto the rear edge of the roller blind fabric and substantially has the function to hold the rear edge of the roller blind 10 tensioned in a direction transverse to the longitudinal direction of the vehicle. In principle, however, the roller blind system 8 also works without coil body; the roller blind fabric 11 then freely winds up between guiding strips, here spring steel strips 18, when the same leave the guide rails 14.

Along the longitudinal edges of the roller blind 10, i.e. in the region associated to the guide rails 14, a spring steel strip 18 each is provided as guiding strip which is designed such that it independently rolls up to form a spiral, when it is not kept straight in the guide rails 14.

At its edges, the roller blind fabric 11 is adhered to the spring steel strips 18 or connected with the same in some other suitable way.

When the roller blind 10 is shifted back, in order to clear the opening 7, the rear region of the roller blind 10 is pushed out of the guide rails 14. Automatically and on its own, it is rolled up by the spring steel strips 18 onto the coil body 16 to form a coil 19 (see in particular FIG. 4). Due to the pretension of the spring steel strips 18 and due to the coil body 16, this coil 19 is stretched tight. The roller blind coil 19 rests against a wall 24, which defines a receiving space for the roller blind 10 wound up.

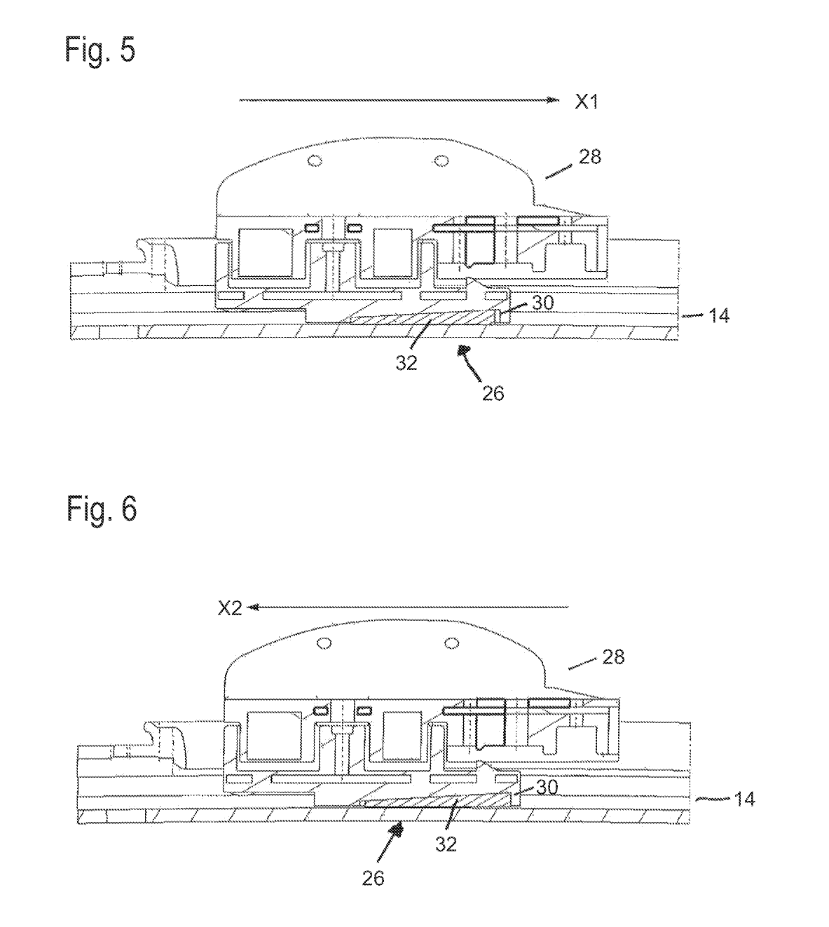

FIGS. 5 and 6 show a first embodiment of a roller blind system according to the invention with a device 26 for increasing the opening force of the roller blind system.

At the lateral ends of the crossrail 12 a slider 28 each is located, which is guided in the guide rail 14, so that the crossrail 12 is shiftable via its sliders 28.

The slider 28 includes a device 26 for increasing the opening force, which comprises a wedge guide 30 and a friction wedge 32 which is guided in the wedge guide 30. The friction wedge 32 also slides along a wall of the guide rail 14, preferably along the central web of the guide rail 14. Optionally, the slider 28 itself cannot at all contact the central web shown in FIG. 5 or even the guide rail 14, so that the friction wedge 32 alone makes contact with the guide rail.

At its end facing away from the coil (cf. FIG. 4), the wedge guide 30 has a smaller height than at its end facing the coil. The friction wedge 32 correspondingly is inserted into the wedge guide 30.

The friction wedge 32 is at least partly elastic and in part is made of an elastomer, e.g. a silicone material.

A device 26 for increasing the opening force is formed thereby, which is designed and arranged such that the device 26 produces an additional force in opening direction X1 (see FIG. 5), which is greater than an additional force produced by the device 26 in closing direction X2 (see FIG. 6).

The required opening force for moving the roller blind 10 in opening direction and the required closing force for moving the roller blind 10 in closing direction here lie in a tolerance field of e.g. 20±5 N. The additional forces produced in opening direction and closing direction on the part of the device 26 for increasing the opening force are dimensioned such that the total opening force required and the total closing force required lie close to each other and within the specified tolerance field.

The device 26 for increasing the opening force also can increase the closing force, which however is not necessarily the case, for moving the roller blind 10 in closing direction, as the friction wedge 32 also produces a frictional force during a movement of the slider 28 in closing direction X2 by sliding along the guide rail 14.

The device 26 for increasing the opening force increases the resistance for the movement of the roller blind 10. This is accomplished in that with the friction wedge 32 the roller blind system 8 includes a friction element which is arranged such that it artificially increases the opening force. The friction element is designed and arranged such that it produces a higher frictional force at least in opening direction. This frictional force is greater than an additional force produced by the friction element in closing direction. During a movement in opening direction X1 the friction wedge 32 is transferred into a first position, which is shown in FIG. 5, in which due to the opening movement and a resulting displacement in the wedge guide 30 the friction wedge 32 is pressed and braced against the lower end of the wedge guide 30 and hence against the inner wall of the guide rail 14. Optionally, the friction wedge 32 on the end face also can strike against the end-face end of the wedge guide 30 as shown on the left in FIG. 5.

During and as a result of a movement in closing direction X2 the friction wedge 32 is transferred into a second position (see FIG. 6), in which as a result of the closing movement the friction wedge 32 in the wedge guide 30 strikes against the higher end-face end of the wedge guide 30 and hence is not pressed against the central web and hence against a wall of the guide and is not braced. The second position however also can be formed such that the bracing of the friction wedge 32 is smaller than in the first position, because the friction wedge 32 is pressed and compressed less.

During a movement of the roller blind 10 in opening direction X1, the friction wedge 32 thus is urged against the guide rail 14, in order to produce an additional frictional force.

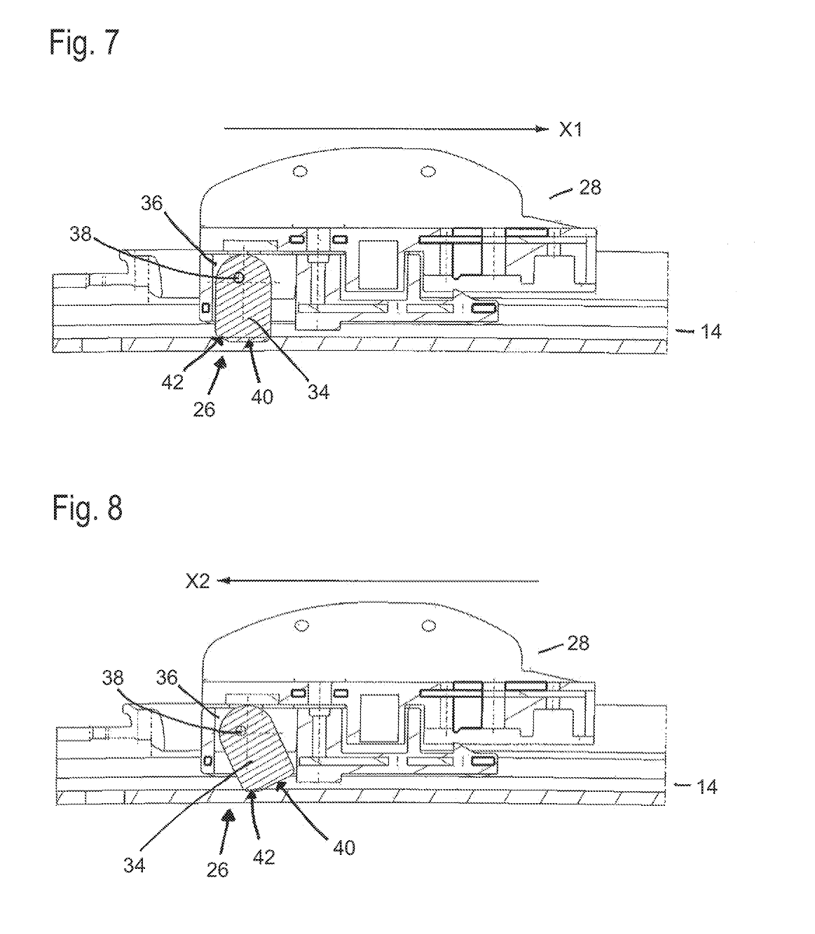

FIGS. 7 and 8 show a second embodiment of a roller blind system according to the invention with a device 26 for increasing the opening force.

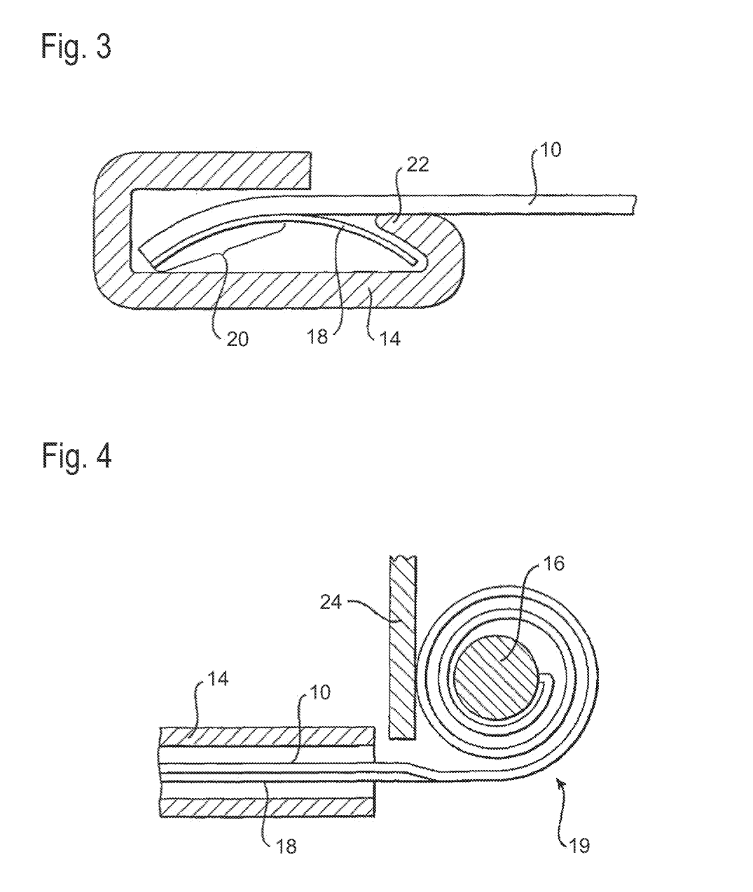

The roller blind system and the device 26 for increasing the opening force substantially are identical with the roller blind system described in FIGS. 1 to 6 with the exception of the following differences:

Instead of a friction wedge 32, the device 26 for increasing the opening force includes a friction piece 34 which is pivotally mounted on a pin 38 in a friction piece guide 36 provided in the slider 28.

The friction piece 34 is partly elastic and includes a sleeve or a friction layer of silicone material.

The friction piece 34 has a braking surface 40 and a sliding surface 42, e.g. in the form of a chamfer 42.

The sliding surface 42 for example is a surface adjacent to or adjoining the braking surface 40, which has a surface area smaller than the braking surface 40.

In the example shown in FIGS. 7 and 8, the sliding surface 42 is formed as chamfer towards the braking surface 40.

During and as a result of a movement of the slider 28 in opening direction X1 the friction piece 34 is pivoted such that the braking surface 40 is pressed against the guide rail 14 and e.g. fully rests on the same. A frictional force thereby is produced, which is greater than in the position of the friction piece 34 shown in FIG. 8. The friction piece guide 36 also supports the friction piece 34 such that it is not pivoted even further against the opening direction due to the movement of the slider 28 in opening direction from the position shown in FIG. 7, so that ultimately the friction piece is slightly wedged in the guide rail 14 and an increased frictional force is obtained.

During a movement of the slider 28 in closing direction X2, the friction piece 34 is pivoted such that the sliding chamfer 42 slides along the guide rail 14 with little resistance, as in this position in contrast to the position mentioned above no stable dead center position is reached and the friction piece is not braced in the guide rail 14.

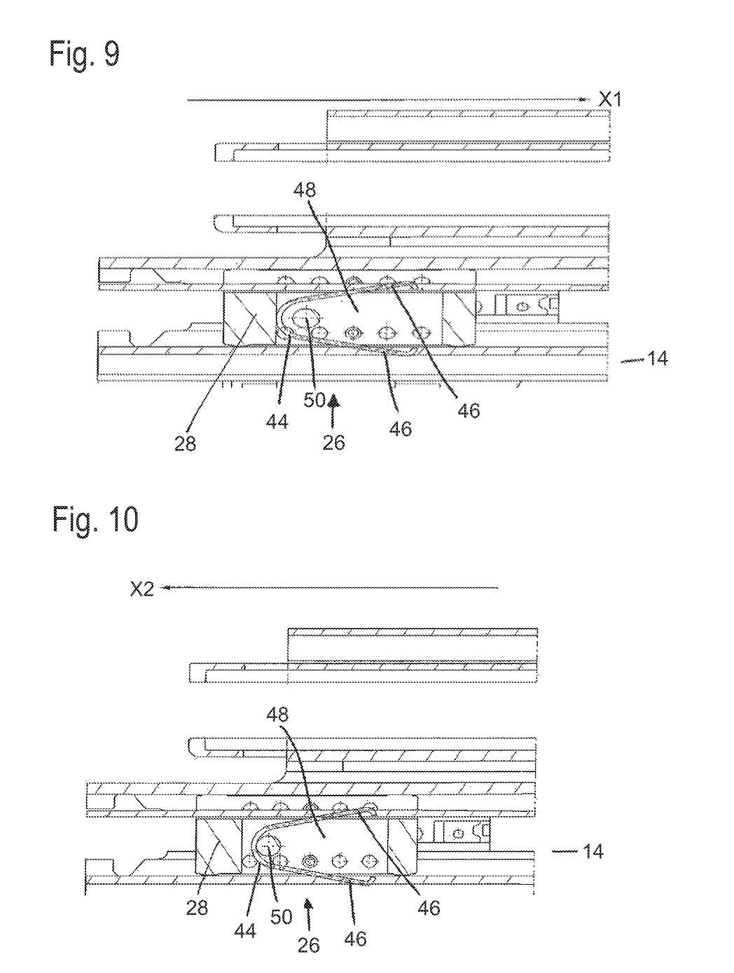

FIGS. 9 and 10 show a third embodiment of a roller blind system according to the invention with a device 26 for increasing the opening force.

The roller blind system and the device 26 for increasing the opening force substantially are identical with the roller blind system described in FIGS. 1 to 6 with the exception of the following differences:

The friction element here is a U-shaped expanding spring 44 with spring arms 46 in an expanding spring receptacle 48 in the slider.

By a movement of the slider in opening direction X1 the expanding spring 44 is urged against a wall of the expanding spring receptacle 48, and the spring arms 46 can tighten against the guide rail 14 and the slider 28.

During a movement in closing direction X2 the expanding spring 44 is carried along by a pin 50, which is located within the expanding spring receptacle 48, and the tightening of the expanding spring 44 is released.

The additionally produced frictional force of the expanding spring 44 can be effected by an adjustment of the surface roughnesses of the expanding spring 44 and the guide rail 14.

In general, it should be emphasized that it is also possible to vary the resistance produced by the friction element, for example in that the pressing force of the friction element is adjustable. This can be effected e.g. by interposition of an adjusting screw with which the position of the friction element relative to the slider is adjustable. The stiffness of the friction element also might be variable, e.g. by inserting parts of different stiffness into the friction element.

1. A roller blind system for a sliding roof with at least one guide rail and with a roller blind with a roller blind fabric mounted on at least one guiding strip, wherein the guiding strip is sectionally guided in the guide rail and its end is located outside the guide rail and contracts to form a coil during a movement of the roller blind in an opening direction, wherein at least one device for increasing an opening force of the roller blind is provided, which is designed and arranged such that the device produces an additional force at least in the opening direction.

2. The roller blind system according to claim 1, wherein the additional force is greater than an additional force produced by the device in a closing direction.

3. The roller blind system according to claim 1, wherein the device for increasing the opening force also increases a closing force for moving the roller blind in a closing direction.

4. The roller blind system according to claim 1, wherein the device for increasing the opening force increases a resistance for movement of the roller blind.

5. The roller blind system according to claim 1, wherein the device includes at least one friction element that is arranged such that it artificially increases the opening force.

6. The roller blind system according to claim 5, wherein the friction element is designed and arranged such that it produces a higher frictional force in the opening direction than in a closing direction.

7. The roller blind system according to claim 5, wherein the friction element is located at least two different positions wherein the resistance caused by the friction element is different.

8. The roller blind system according to claim 7, wherein during a movement in the opening direction the friction element is in a first position in which the friction element is pressed and braced against a wall, and during a movement in the closing direction the friction element is transferred into a second position in which the friction element is not pressed against a wall and is not braced, wherein by changing the direction of movement of the roller blind the friction element is transferred into either the first position or the second position from either the second position or the first position.

9. The roller blind system according to claim 8, wherein the friction element is a friction wedge.

10. The roller blind system according to claim 8, wherein the friction element is a pivotally mounted friction piece.

11. The roller blind system according to claim 8, wherein the friction element is an expanding spring.

12. The roller blind system according to claim 8, wherein the friction element is at least partly elastic.

13. The roller blind system according to claim 8, wherein the friction element is at least partly made of a silicone material.

14. The roller blind system according to claim 8, wherein during a movement of the roller blind in the opening direction the friction element is urged against the guide rail, in order to produce an additional frictional force.

15. The roller blind system according to claim 8, wherein the roller blind system includes at least one slider which is guided in the guide rail, wherein the friction element is guided in the slider.
